(19) United States
(12) Patent Application Publication
(10) Pub. No.: US 2022/0289928 A1
(43) Pub. Date: Sep. 15, 2022

(54) Method for manufacturing a plurality of bodies made of a porous material

(71) Applicant: BASF SE, Ludwigshafen am Rhein (DE)

(72) Inventors: Dirk WEINRICH, Lemfoerde (DE); Volker Vogelsang, Lemfoerde (DE); Rene Thomas Wiegmann, Lemfoerde (DE); Sohaji Movahhed, Koeln (DE); Marc Fricke, Lemfoerde (DE); Torben Kaminsky, Lemfoerde (DE); Maria Thomas, Lemfoerde (DE); Joerg Erbes, Ludwigshafen (DE); Wibke Loelsberg, Ludwigshafen am Rhein (DE)

(73) Assignee: BASF SE, Ludwigshafen am Rhein (DE)

(21) Appl. No.: 17/753,147

(22) PCT Filed: Aug. 25, 2020
(86) PCT No.: PCT/EP2020/073685

§ 371 Date: Feb. 22, 2022

(30) Foreign Application Priority Data
Aug. 26, 2019 (EP) 19193602.0

(51) Int. Cl. C08J 9/28; B01J 13/00

(52) U.S. Cl. CPC C08J 9/286; B01J 13/0091; C08J 2201/05; C08J 2205/026

(57) ABSTRACT

A method can be used for manufacturing one or more bodies made of a porous material derived from precursors of the porous material in a sol-gel process. The method involves filling precursors of the porous material into a mold defining the shape of the body, where the precursors include at least two reactive components and a solvent, and forming a gel body. The step is then repeated so as to form several gel bodies. The gel bodies are then removed from the mold after a predetermined time in which the gel bodies are formed from the precursors of the porous material. The gel bodies are arranged adjacent to one another, a spacer is provided between two adjacent gel bodies so as to provide a clearance therebetween, and the solvent is then removed from the gel bodies.

### TECHNICAL FIELD

The present invention relates to a method for manufacturing a plurality of bodies made of a porous material derived from precursors of the porous material in a sol-gel process.

### BACKGROUND

Porous materials, for example polymer foams, having pores in the size range of a few microns or significantly below and a high porosity of at least 70% are particularly good thermal insulators on the basis of theoretical considerations.

Such porous materials having a small average pore diameter are, for example, organic aerogels or xerogels which are produced with a sol-gel process and subsequent drying. In the sol-gel process, a sol based on a reactive organic gel precursor is first produced and the sol is then gelled by means of a crosslinking reaction to form a gel. To obtain a porous material, for example an aerogel or xerogel, from the gel, the liquid has to be removed. This step will hereinafter be referred to as drying in the interests of simplicity. For example, in case of an aerogel, pores can collapse requiring typically special drying processes such as supercritical drying with carbon dioxide.

Particularly, during the process for preparing a porous material, a mixture is provided that comprises the reactive precursors and a solvent. In order to define the shape of the porous material, a mold into which this mixture is filled may be basically used. After gelling and before drying or after drying, the thus formed body made of a porous material has to be removed from the mold depending on the process and material.

WO 2016/150684 A1 discloses a process for preparing a porous material, at least providing a mixture (I) comprising a composition (A) comprising components suitable to form an organic gel and a solvent (B), reacting the components in the composition (A) in the presence of the solvent (B) to form a gel, and drying of the gel obtained in step b), wherein the composition (A) comprises a catalyst system (CS) comprising a catalyst component (C1) selected from the group consisting of alkali metal and earth alkali metal, ammonium, ionic liquid salts of a saturated or unsaturated monocarboxylic acid and a carboxylic acid as catalyst component (C2). The invention further relates to the porous materials which can be obtained in this way and the use of the porous materials as thermal insulation material and in vacuum insulation panels, in particular in interior or exterior thermal insulation systems as well as in water tank or ice maker insulation systems.

US 2005/0159497 A1 discloses method and devices for rapidly fabricating monolithic aerogels, including aerogels containing chemical sensing agents. The method involves providing a gel precursor solution or a preformed gel in a sealed vessel with the gel or gel precursor at least partially filling the internal volume of the vessel and the sealed vessel being positioned between opposed plates of a hot press; heating and applying a restraining force to the sealed vessel via the hot press plates (where the restraining force is sufficient to minimize substantial venting of the vessel); and then controllably releasing the applied restraining force under conditions effective to form the aerogel. A preferred device for practicing the method is in the form of a hot press having upper and lower press plates, and a mold positioned between the upper and lower plates. Doped aerogel monoliths and their use as chemical sensors are also described.

### SUMMARY

A particular problem associated with the use of molds is that the mobile phase such as CO₂ must reach the gel surface in order to remove solvent from the gel. During the removal of the solvent, a diffusion of the solvent into the surrounding atmosphere is preferred on all sides of the gel in order to carry out the drying as fast as possible. The drying time increases exponentially with the maximum distance between any point in the gel and the surrounding atmosphere, which is influenced by gel thickness and accessibility of the gel surfaces to the mobile phase. As typical molds with surfaces impermeable to the mobile phase do not allow optimal removal of the solvent from the gelled body due to reduced accessibility of the mobile phase to all sides of the gel, it can be advantageous for the gelled body to be removed from the mold and to be dried separately in cases of particularly thick gels. However, in some cases the gelled body is not stable in its shape and requires to be supported during drying. If several gel bodies are dried simultaneously, they need to be separated from each other in order to enable the mobile phase to access all gel bodies from all sides.

It was therefore an object of the invention to avoid the abovementioned disadvantages. In particular, a method for manufacturing a body made of a porous material should be provided that allows keep the gelled body in its desired shape and to provide a time-efficient removal of the solvent from the gel.

According to the present invention, this object is solved by a method for manufacturing a plurality of bodies made of a porous material derived from precursors of the porous material in a sol-gel process, comprising:

(i) filling precursors of the porous material into a mold defining the shape of the body, wherein the precursors include at least two reactive components CA, CB and a solvent S, and forming a gel body,
(ii) repeating step (i) so as to form a plurality of gel bodies,
(iii) removing the gel bodies from the mold after a predetermined time in which the bodies are formed from the precursors of the porous material,
(iv) arranging the bodies adjacent to one another,
(v) providing at least one spacer between two adjacent gel bodies so as to provide a clearance therebetween,
(vi) removing the solvent S from the gel bodies.

The term “spacer” as used herein is a broad term and is to be given its ordinary and customary meaning to a person of ordinary skill in the art and is not to be limited to a special or customized meaning. The term specifically may refer, without limitation, to a solid material configured to separate two parts in an assembly while providing a clearance between the parts not filled or free of the solid material. In the present disclosure, a spacer is configured to separate two adjacent gel bodies with a clearance between the adjacent gel bodies. Further, the spacer may be configured to provide mechanical support to the two adjacent gel bodies, particularly at the sides of the gel bodies facing one another. Due to the separation of the two adjacent gel bodies, the clearance is formed between the adjacent gel bodies, which is not filled with solid material of the spacer. The clearance allows to remove the solvent from the gel bodies even through the clearance. With other words, the clearance formed by the spacer allows to remove the solvent from the gel bodies at all sides thereof and even at the side where the spacer is located as the solvent may also flow through the clearance. For this purpose, the spacer is formed so as to provide a significant and predetermined amount of opening area or volume through which the solvent may move while drying the gel bodies.

According to the method of the present invention, it was surprisingly found that due to the provision of a specially designed spacer between adjacent gel bodies, sufficient mechanical support for the gel bodies to maintain their shape as well as a sufficient clearance between the gel bodies allowing time-efficient removal of the solvent by the mobile phase can be realized. The removal of the solvent leaves pores formed by the cavities that contained the solvent. Thus, after removal of the solvent, the bodies are porous and, therefore, may be identified as bodies made of a porous material.

The porous materials of the present invention are preferably aerogels or xerogels.

The spacer may be a grid assembly comprising a first grid and a second grid connected to one another, wherein the first grid comprising first openings and the second grid comprises second openings, wherein the first openings and second openings are shifted to one another. Thus, the first and second openings create an open path in the plane of the two grids allowing the mobile phase with the solvent from the gel to flow therethrough.

The grid assembly may comprise a thickness of 1.0 mm to 4.0 mm, preferably 1.25 mm to 3.5 mm and more preferably 1.5 mm to 2.5 mm. Thus, the grid assembly is sufficiently stable to mechanically support the gel bodies to maintain their shape.

The first openings and/or the second openings may be arranged in a regular or irregular pattern. Thus, a broad range of possible arrangements for the openings are feasible.

The first openings and/or the second openings may comprise identical or different opening areas. Thus, opening areas may be adapted to the respective application such as body shape or the like.

The first openings and/or the second openings may comprise identical or different shapes. Thus, a broad range of possible shapes for the openings are feasible.

The first openings and/or the second openings may comprise a circular, oval, elliptical, polygonal, polygonal including rounded edges, rectangular or square shape. Thus, a broad range of possible shapes for the openings are feasible.

The method may further comprise at least partially providing surfaces of the first grid and/or second grid with a coating made of a material being electrically dissipative and non-sticky to the gel bodies. As the grids may be provided with a coating made of a material being electrically dissipative and non-sticky to the precursors of the porous material and the body, areas of the grids intended to contact the precursors are prevented from sticking to the precursors, the porous material and/or any intermediate product thereof. Thus, the body made of a porous material may be reliably and completely removed from the grids. Further, as the coating is made of an electrically dissipative material, the grids are allowed to be used in explosion protection environments as an explosion due to electrostatic charge of the grids, sol and/or gel are prevented.

A total opening area of the first and second openings may be 40% to 95% of a facing outer surface of a body. Thus, rather larger opening areas may be realized.

The method may further comprise integrally, preferably monolithically, forming each of the gel bodies with the spacer. Thus, the spacer may be formed as a part of the body which avoids the provision of a separate constructional member serving as spacer between adjacent gel bodies.

The spacer may include a plurality of protrusions protruding from at least one surface of the gel bodies. Thus, the protrusions serve to provide the clearance between adjacent gel bodies.

The method may further comprise forming the protrusions only on one surface of each of the gel bodies, wherein the gel bodies are arranged adjacent to one another such that the surface including the protrusions of one of the gel bodies faces a surface without protrusions of the respective adjacent body. Thus, the protrusions may be formed on the gel bodies themselves such that a separate spacer may be omitted. Thereby, the process steps are reduced by at least one step.

Each of the protrusions may comprise a circular cross-sectional shape with a diameter of 1.0 to 5.0 mm, preferably 1.25 mm to 4.0 mm and more preferably 1.5 mm to 2.5 mm. Thus, even though the protrusions are rather small, they are sufficiently dimensioned to provide the clearance.

The protrusions may be arranged in a regular or irregular pattern. Thus, the protrusions may be arranged as appropriate as long as they provide a sufficient clearance.

The protrusions may have identical or different shapes. Thus, the protrusions may be shaped as appropriate as long as they provide a sufficient clearance.

The protrusions may have a height of 0.1 mm to 20.0 mm, preferably 0.5 mm to 5.0 mm and more preferably 1.0 mm to 3.0 mm. This height defines the distance from the adjacent body and, thus, the size of the clearance. The defined height optimizes the spatial arrangement of the gel bodies and the clearance therebetween.

The protrusions may be arranged such that a minimum distance between outer surfaces of adjacent protrusions is 0.1 mm and preferably 0.5 mm. Thus, a sufficient flow of the solvent between the protrusions is ensured.

The protrusions may be formed as truncated cones. Thus, the protrusions have a flattened leading end and not a sharp tip such that damage of the neighboring body is avoided.

The method may further comprise removing the protrusions after removing the solvent S from the gel bodies. Thus, the bodies are plane at the end of the method such that the bodies do not comprise any uneven parts that may be an obstacle for some applications of the bodies such that as isolating slabs.

The gel bodies may be formed as slabs having a cuboid, cylindrical or polygonal shape, wherein the gel bodies are arranged such that side surfaces of the cuboid, cylindrical or polygonal shape having the greatest surface area are oriented substantially perpendicular with respect to a direction of gravity. Thus, the slabs may be oriented substantially vertical during the removing step. The term “substantially perpendicular” as used herein is to be understood to mean a deviation from the exact perpendicular orientation of not more than 10° and preferably not more than 5°.

Alternatively, the gel bodies may be formed as slabs having a cuboid, cylindrical or polygonal shape, wherein the gel bodies are arranged such that side surfaces of the cuboid, cylindrical or polygonal shape having the greatest surface area are oriented substantially parallel with respect to a direction of gravity. Thus, the slabs may be oriented substantially horizontal during the removing step. The term “substantially parallel” as used herein is to be understood to mean a deviation from the exact parallel orientation of not more than 10° and preferably not more than 5°.

The gel bodies may be arranged such that edges of the cuboid, cylindrical or polygonal shape having the greatest dimension are oriented substantially perpendicular with respect to a direction of gravity.

The gel bodies may be formed as slabs, wherein the slabs comprise a length of at least 10 cm and a width in a range of at least 10 cm. Such slabs comprise a broad technical field of application such as isolating slabs. For practical reasons, the upper limit for the length and/or the width may be 200 cm or even 100 cm.

The gel bodies may be formed as slabs, wherein the slabs comprise a thickness of at least 0.5 mm. For practical reasons, the upper limit for the thickness may be 25.0 mm, 20.0 mm or even 15.0 mm. Such slabs comprise a broad technical field of application such that as isolating slabs.

The spacer may be a grid comprising grid openings. Thus, a sufficient support as well as clearance between neighboring gel bodies is provided.

The grid may be configured to carry a body and to support another grid disposed thereon without the body being engaged by the other grid. Thus, a deflection or deformation of the gel bodies may be prevented.

The grid may comprise an outer rim, wherein the outer rim is configured to support another grid disposed thereon without the body being engaged by the other grid. Thus, the body is well protected on the grid.

The grid openings may comprise identical or different opening areas. Thus, the opening areas may be defined as appropriate.

The grid openings may be arranged in a regular or irregular pattern. Thus, the opening areas may be arranged as appropriate.

The grid may comprise struts defining the openings, wherein the struts comprise a width of 1.0 mm to 5.0 mm, preferably 1.25 mm to 4.5 mm and more preferably 1.5 mm to 4.0 mm. Thus, a sufficient support of the body as well as a sufficient opening area is given.

The gel bodies may be formed as slabs having a cuboid, cylindrical or polygonal shape, wherein the gel bodies are arranged such that side surfaces of the cuboid shape, cylindrical or polygonal having the greatest surface area are oriented substantially perpendicular with respect to a direction of gravity. Thus, the slabs may be oriented substantially horizontal during the removing step. The term “substantially perpendicular” as used herein is to be understood to mean a deviation from the exact parallel orientation of not more than 10° and preferably not more than 5°.

The method may further comprise at least partially providing surfaces of the grid with a coating made of a material being electrically dissipative and non-sticky to the gel bodies. As surfaces of the grid are at least partially provided with a coating made of a material being electrically dissipative and non-sticky to the precursors of the porous material and the body, areas of the grid intended to contact the bodies are prevented from sticking to the bodies, the porous material and/or any intermediate product thereof. Thus, the body made of a porous material may be reliably and completely removed from the grid. Further, as the coating is made of an electrically dissipative material, the grid is allowed to be used in explosion protection environments as an explosion due to electrostatic charge of the grid, sol and/or gel are prevented.

The removing the solvent from the body may be performed by means of supercritical drying or convective drying. Thus, the solvent may be reliably removed.

A layer of non-woven fabric, metal foam or a sintered sheet may also be used as spacer.

Further, a body made of a porous material, which is obtained or obtainable by the process according as described above is disclosed.

The body or the body obtained or obtainable by the process as described above may be used as thermal insulation material or for vacuum insulation panels. The porous materials which can be obtained according to the invention have advantageous thermal properties and also further advantageous properties such as simple processability and high mechanical stability, for example low brittleness.

According to a further development of the present invention, the body made of a porous material is used in interior or exterior thermal insulation systems. The porous materials which can be obtained according to the invention have advantageous thermal properties and also further advantageous properties such as simple processability and high mechanical stability, for example low brittleness.

Preferred embodiments may be found in the claims and the description. Combinations of preferred embodiments do not go outside the scope of the present invention. Preferred embodiments of the components used are described below.

Organic and inorganic aerogels and xerogels as well as processes for their preparation are known from the state of the art. In the sol-gel process, a sol based on a reactive gel precursor is first produced and the sol is then gelled by means of a crosslinking reaction to form a gel. To obtain a porous material, for example an aerogel, from the gel, the liquid has to be removed. This step will hereinafter be referred to as drying in the interests of simplicity.

It is generally known that gel monoliths or particles based on organic (e.g. PU) or inorganic (e.g. silica) precursors can be dried, preferably via supercritical extraction (i.e. using a medium in the supercritical state, e.g. CO2) to obtain organic, inorganic or hybrid aerogels.

The chemical nature of the gel can vary. It is possible that an organic gel is provided but also inorganic gels can be subjected to the process according to the present invention. Suitable methods to prepare organic or inorganic gels are known to the person skilled in the art. Preferably, the gel is an organic gel according to the present invention.

In principle, the process does not depend on the gel chemistry. Thus, according to the present invention, any organic or inorganic gel can be used in the process, for example organic gels, such as gels based on synthetic polymers or biopolymers, or inorganic gels.

Therefore, according to a further embodiment, the present invention is also directed to the process as disclosed above, wherein the gel is an organic gel.

Organic xerogels and aerogels preferred for the purposes of the present invention are described below.

It is preferable that the organic aerogel or xerogel is based on isocyanates and optionally on other components that are reactive toward isocyanates. By way of example, the organic aerogels or xerogels can be based on isocyanates and on OH-functional and/or NH-functional compounds.

Preference is given in the invention by way of example to organic xerogels based on polyurethane, polyisocyanurate, or polyurea, or organic aerogels based on polyurethane, polyisocyanurate, or polyurea.

Accordingly, one preferred embodiment of the present invention provides a composite element comprising a profile and an insulating core enclosed at least to some extent by the profile, as described above, where the organic porous material is one selected from the group of organic xerogels based on polyurethane, polyisocyanurate, or polyurea, organic aerogels based on polyurethane, polyisocyanurate, or polyurea, and combinations of two or more thereof.

It is particularly preferable that the organic aerogel or xerogel is based on isocyanates and on components reactive toward isocyanates, where at least one polyfunctional aromatic amine is used as component reactive toward isocyanates. It is preferable that the organic xerogel or aerogel is based on polyurea and/or polyisocyanurate.

“Based on polyurea” means that at least 50 mol %, preferably at least 70 mol %, in particular at least 90 mol %, of the linkages of the monomer units in the organic xerogel or aerogel take the form of urethane linkages. “Based on polyurea” means that at least 50 mol %, preferably at least 70 mol %, in particular at least 90 mol %, of the linkages of the monomer units in the organic xerogel or aerogel take the form of urea linkages. “Based on polyisocyanurate” means that at least 50 mol %, preferably at least 70 mol %, in particular at least 90 mol %, of the linkages of the monomer units in the organic xerogel or aerogel take the form of isocyanurate linkages. “Based on polyurea and/or polyisocyanurate” means that at least 50 mol %, preferably at least 70 mol %, in particular at least 90 mol %, of the linkages of the monomer units in the organic xerogel or aerogel take the form of urea linkages and/or isocyanurate linkages.

The composite elements of the invention here can also comprise combinations of various aerogels and xerogels. It is also possible for the purposes of the present invention that the composite element comprises a plurality of insulating cores. It is also possible for the purposes of the invention that the composite element comprises, alongside the organic porous material, another insulation material, for example a polyurethane.

The term organic porous material is used below to refer to the organic aerogel or xerogel used in the invention.

It is preferable that the organic porous material used is obtained in a process which comprises the following steps:

(a) reaction of at least one polyfunctional isocyanate (a1) and of at least one polyfunctional aromatic amine (a2) in a solvent optionally in the presence of water as component (a3) and optionally in the presence of at least one catalyst (a4);
(b) removal of the solvent to give the aerogel or xerogel.

Components (a1) to (a4) preferably used for the purposes of step (a), and the quantitative proportions, are explained below.

The term component (a1) is used below for all of the polyfunctional isocyanates (a1). Correspondingly, the term component (a2) is used below for all of the polyfunctional aromatic amines (a2). It is obvious to a person skilled in the art that the monomer components mentioned are present in reacted form in the organic porous material.

For the purposes of the present invention, the functionality of a compound means the number of reactive groups per molecule. In the case of monomer component (a1), the functionality is the number of isocyanate groups per molecule. In the case of the amino groups of monomer component (a2), the functionality is the number of reactive amino groups per molecule. A polyfunctional compound here has a functionality of at least 2.

If mixtures of compounds with different functionality are used as component (a1) or (a2), the functionality of the component is in each case obtained from the number average of the functionality of the individual compounds. A polyfunctional compound comprises at least two of the abovementioned functional groups per molecule.

Component (a1)

It is preferable to use, as component (a1), at least one polyfunctional isocyanate.

For the purposes of the process of the invention, the amount used of component (a1) is preferably at least 20% by weight, in particular at least 30% by weight, particularly preferably at least 40% by weight, very particularly preferably at least 55% by weight, in particular at least 68% by weight, based in each case on the total weight of components (a1), (a2), and, where relevant, (a3), which is 100% by weight. For the purposes of the process of the invention, the amount used of component (a1) is moreover preferably at most 99.8% by weight, in particular at most 99.3% by weight, particularly preferably at most 97.5% by weight, based in each case on the total weight of components (a1), (a2), and, where relevant, (a3), which is 100% by weight. Polyfunctional isocyanates that can be used are aromatic, aliphatic, cycloaliphatic, and/or araliphatic isocyanates. Polyfunctional isocyanates of this type are known per se or can be produced by methods known per se. The polyfunctional isocyanates can in particular also be used in the form of mixtures, and in this case component (a1) then comprises various polyfunctional isocyanates. Polyfunctional isocyanates that can be used as monomer units (a1) have two or more than two isocyanate groups per molecule of the monomer component (where the term diisocyanates is used below for the former).

Particularly suitable compounds are diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate, and/or p-phenylene diisocyanate (PPDI), tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethyl-cyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and dicyclohexylmethane 4,4′-, 2,4′-, and/or 2,2′-diisocyanate.

Aromatic isocyanates are preferred as polyfunctional isocyanates (a1). This applies in particular when water is used as component (a3).

The following are particularly preferred embodiments of polyfunctional isocyanates of component (a1):
i) polyfunctional isocyanates based on tolylene diisocyanate (TDI), in particular 2,4-TDI or 2,6-TDI or a mixture of 2,4- and 2,6-TDI;
ii) polyfunctional isocyanates based on diphenylmethane diisocyanate (MDI), in particular 2,2′-MDI or 2,4′-MDI or 4,4′-MDI or oligomeric MDI, which is also termed polyphenyl polymethylene isocyanate, or a mixture of two or three of the abovementioned diphenylmethane diisocyanates, or crude MDI, which arises during the production of MDI, or a mixture of at least one oligomer of MDI and of at least one of the abovementioned low-molecular-weight MDI derivatives;
iii) a mixture of at least one aromatic isocyanate of embodiment i) and of at least one aromatic isocyanate of embodiment ii).

Oligomeric diphenylmethane diisocyanate is particularly preferred as polyfunctional isocyanate. Oligomeric diphenylmethane diisocyanate (termed oligomeric MDI below) involves a mixture of a plurality of oligomeric condensates and therefore of derivatives of diphenylmethane diisocyanate (MDI). The polyfunctional isocyanates can preferably also be composed of mixtures of monomeric aromatic diisocyanates and of oligomeric MDI.

Oligomeric MDI comprises one or more polynuclear condensates of MDI with a functionality of more than 2, in particular 3 or 4 or 5. Oligomeric MDI is known and is often termed polyphenyl polymethylene isocyanate or else polymeric MDI. Oligomeric MDI is usually composed of a mixture of MDI-based isocyanates with different functionality. Oligomeric MDI is usually used in a mixture with monomeric MDI.

The (average) functionality of an isocyanate which comprises oligomeric MDI can vary in the range from about 2.2 to about 5, in particular from 2.4 to 3.5, in particular from 2.5 to 3. This type of mixture of MDI-based polyfunctional isocyanates with different functionalities is in particular crude MDI, which is produced during the production of MDI, usually with catalysis by hydrochloric acid, in the form of intermediate product of crude MDI production.

Polyfunctional isocyanates and mixtures of a plurality of polyfunctional isocyanates based on MDI are known and are marketed byway of example by BASF Polyurethanes GmbH with trademark Lupranat®.

It is preferable that the functionality of component (a1) is at least two, in particular at least 2.2, and particularly preferably at least 2.4. The functionality of component (a1) is preferably from 2.2 to 4 and particularly preferably from 2.4 to 3.

The content of isocyanate groups of component (a1) is preferably from 5 to 10 mmol/g, in particular from 6 to 9 mmol/g, particularly preferably from 7 to 8.5 mmol/g. The person skilled in the art is aware that the content of isocyanate groups in mmol/g and the property known as equivalence weight in g/equivalent have a reciprocal relationship. The content of isocyanate groups in mmol/g is obtained from the content in % by weight in accordance with ASTM D5155-96 A.

In one preferred embodiment, component (a1) is composed of at least one polyfunctional isocyanate selected from diphenylmethane 4,4′-diisocyanate, diphenylmethane 2,4′-diisocyanate, diphenylmethane 2,2′-diisocyanate, and oligomeric diphenylmethane diisocyanate. For the purposes of this preferred embodiment, component (a1) particularly preferably comprises oligomeric diphenylmethane diisocyanate and has a functionality of at least 2.4.

The viscosity of component (a1) used can vary widely. It is preferable that component (a1) has a viscosity of from 100 to 3000 mPa·s, particularly from 200 to 2500 mPa·s.

Component (a2)

The invention uses, as component (a2), at least one polyfunctional OH-functionalized or NH-functionalized compound.

For the purposes of the process preferred in the invention, component (a2) is at least one polyfunctional aromatic amine.

Component (a2) can be to some extent produced in situ. In this type of embodiment, the reaction for the purposes of step (a) takes place in the presence of water (a3). Water reacts with the isocyanate groups to give amino groups with release of CO₂. Polyfunctional amines are therefore to some extent produced as intermediate product (in situ). During the course of the reaction, they are reacted with isocyanate groups to give urea linkages.

In this preferred embodiment, the reaction is carried out in the presence of water (a3) and of a polyfunctional aromatic amine as component (a2), and also optionally in the presence of a catalyst (a4).

In another embodiment, likewise preferred, the reaction of component (a1) and of a polyfunctional aromatic amine as component (a2) is optionally carried out in the presence of a catalyst (a4). No water (a3) is present here.

Polyfunctional aromatic amines are known per se to the person skilled in the art. Polyfunctional amines are amines which have, per molecule, at least two amino groups reactive toward isocyanates. Groups reactive toward isocyanates here are primary and secondary amino groups, and the reactivity of the primary amino groups here is generally markedly higher than that of the secondary amino groups.

The polyfunctional aromatic amines are preferably binuclear aromatic compounds having two primary amino groups (bifunctional aromatic amines), corresponding tri- or polynuclear aromatic compounds having more than two primary amino groups, or a mixture of the abovementioned compounds. Particularly preferred polyfunctional aromatic amines of component (a2) are isomers and derivatives of diaminodiphenylmethane.

The bifunctional binuclear aromatic amines mentioned are particularly preferably those of the general formula I,

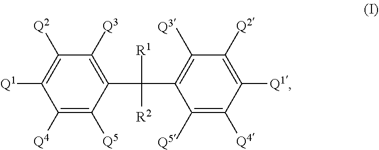

where R¹ and R² can be identical or different and are selected mutually independently from hydrogen and linear or branched alkyl groups having from 1 to 6 carbon atoms, and where all of the substituents Q¹ to Q⁵ and Q^{1′} to Q^{5′} are identical or different and are selected mutually independently from hydrogen, a primary amino group, and a linear or branched alkyl group having from 1 to 12 carbon atoms, where the alkyl group can bear further functional groups, with the proviso that the compound of the general formula I comprises at least two primary amino groups, where at least one of Q¹, Q³, and Q⁵ is a primary amino group, and at least one of Q^{1′}, Q^{3′}, and Q^{5′} is a primary amino group.

In one embodiment, the alkyl groups for the purposes of the substituents Q of the general formula I are selected from methyl, ethyl, n-propyl, isopropyl, n-butyl, sec-butyl, and tert-butyl. Compounds of this type are hereinafter termed substituted aromatic amines (a2-s). However, it is likewise preferable that all of the substituents Q are hydrogen, to the extent that they are not amino groups as defined above (the term used being unsubstituted polyfunctional aromatic amines).

It is preferable that R¹ and R² for the purposes of the general formula I are identical or different and are selected mutually independently from hydrogen, a primary amino group, and a linear or branched alkyl group having from 1 to 6 carbon atoms. It is preferable that R¹ and R² are selected from hydrogen and methyl. It is particularly preferable that R¹═R²═H.

Other suitable polyfunctional aromatic amines (a2) are in particular isomers and derivatives of toluenediamine. Particularly preferred isomers and derivatives of toluenediamine for the purposes of component (a2) are toluene-2,4-diamine and/or toluene-2,6-diamine, and diethyttoluenediamines, in particular 3,5-diethyttoluene-2,4-diamine and/or 3,5-diethyttoluene-2,6-diamine.

It is very particularly preferable that component (a2) comprises at least one polyfunctional aromatic amine selected from 4,4′-diaminodiphenylmethane, 2,4′-diaminodiphenylmethane, 2,2′-diaminodiphenylmethane, and oligomeric diaminodiphenylmethane.

Oligomeric diaminodiphenylmethane comprises one or more polynuclear methylene-bridged condensates of aniline and formaldehyde. Oligomeric MDA comprises at least one, but generally a plurality of, oligomers of MDA having a functionality of more than 2, in particular 3 or 4, or 5. Oligomeric MDA is known or can be produced by methods known per se. Oligomeric MDA is usually used in the form of mixtures with monomeric MDA.

The (average) functionality of a polyfunctional amine of component (a2), where this amine comprises oligomeric MDA, can vary within the range from about 2.3 to about 5, in particular 2.3 to 3.5, and in particular from 2.3 to 3. One such mixture of MDA-based polyfunctional amines having varying functionalities is in particular crude MDA, which is produced in particular during the condensation of aniline with formaldehyde as intermediate product in production of crude MDI, usually catalyzed by hydrochloric acid.

It is particularly preferable that the at least one polyfunctional aromatic amine comprises diaminodiphenylmethane or a derivative of diaminodiphenylmethane. It is particularly preferable that the at least one polyfunctional aromatic amine comprises oligomeric diaminodiphenylmethane. It is particularly preferable that component (a2) comprises oligomeric diaminodiphenylmethane as compound (a2) and that its total functionality is at least 2.1. In particular, component (a2) comprises oligomeric diaminodiphenylmethane and its functionality is at least 2.4. For the purposes of the present invention it is possible to control the reactivity of the primary amino groups by using substituted polyfunctional aromatic amines for the purposes of component (a2). The substituted polyfunctional aromatic amines mentioned, and stated below, hereinafter termed (a2-s), can be used alone or in a mixture with the abovementioned (unsubstituted) diaminodiphenylmethanes (where all Q in formula I are hydrogen, to the extent that they are not NH₂).

In this embodiment, Q², Q⁴, Q^{2′}, and Q^{4′} for the purposes of the formula I described above, inclusive of the attendant definitions, are preferably selected in such a way that the compound of the general formula I has at least one linear or branched alkyl group, where this can bear further functional groups, having from 1 to 12 carbon atoms in α-position with respect to at least one primary amino group bonded to the aromatic ring. It is preferable that Q², Q⁴, Q^{2′}, and Q^{4′} in this embodiment are selected in such a way that the substituted aromatic amine (a2-s) comprises at least two primary amino groups which respectively have one or two linear or branched alkyl groups having from 1 to 12 carbon atoms in α-position, where these can bear further functional groups. To the extent that one or more of Q², Q⁴, Q^{2′}, and Q^{4′} are selected in such a way that they are linear or branched alkyl groups having from 1 to 12 carbon atoms, where these bear further functional groups, preference is then given to amino groups and/or hydroxy groups, and/or halogen atoms, as these functional groups.

It is preferable that the amines (a2-s) are selected from the group consisting of 3,3′,5,5′-tetraalkyl-4,4′-diaminodiphenylmethane, 3,3′,5,5′-tetraalkyl-2,2′-diaminodiphenylmethane, and 3,3′,5,5′-tetraalkyl-2,4′-diaminodiphenylmethane, where the alkyl groups in 3,3′,5 and 5′ position can be identical or different and are selected mutually independently from linear or branched alkyl groups having from 1 to 12 carbon atoms, where these can bear further functional groups. Preference is given to abovementioned alkyl groups methyl, ethyl, n-propyl, isopropyl, n-butyl, sec-butyl or tert-butyl (in each case unsubstituted).

In one embodiment, one of, a plurality of, or all of, the hydrogen atoms of one or more alkyl groups of the substituents Q can have been replaced by halogen atoms, in particular chlorine. As an alternative, one of, a plurality of, or all of, the hydrogen atoms of one or more alkyl groups of the substituents Q can have been replaced by NH₂ or OH. However, it is preferable that the alkyl groups for the purposes of the general formula I are composed of carbon and hydrogen.

In one particularly preferred embodiment, component (a2-s) comprises 3,3′,5,5′-tetraalkyl-4,4′-diaminodiphenylmethane, where the alkyl groups can be identical or different and are selected independently from linear or branched alkyl groups having from 1 to 12 carbon atoms, where these optionally can bear functional groups. Abovementioned alkyl groups are preferably selected from unsubstituted alkyl groups, in particular methyl, ethyl, n-propyl, isopropyl, n-butyl, sec-butyl, and tert-butyl, particularly preferably from methyl and ethyl. Very particular preference is given to 3,3′,5,5′-tetraethyl-4,4′-diaminodiphenylmethane, and/or 3,3′,5,5′-tetramethyl-4,4′-diaminodiphenylmethane.

The abovementioned polyfunctional amines of component (a2) are known per se to the person skilled in the art or can be produced by known methods. One of the known methods is the reaction of aniline or, respectively, of derivatives of aniline with formaldehyde, with acidic catalysis. As explained above, water, as component (a3), can to some extent replace the polyfunctional aromatic amine, in that it reacts with an amount, then calculated in advance, of additional polyfunctional aromatic isocyanate of component (a1) in situ to give a corresponding polyfunctional aromatic amine.

The term organic gel precursor (A) is used below for components (a1) to (a3).

Catalyst (a4)

In one preferred embodiment, the process of the invention is preferably carried out in the presence of at least one catalyst as component (a4).

Catalysts that can be used are in principle any of the catalysts which are known to the person skilled in the art and which accelerate the trimerization of isocyanates (these being known as trimerization catalysts) and/or accelerate the reaction of isocyanates with amino groups (these being known as gel catalysts), and/or—to the extent that water is used—accelerate the reaction of isocyanates with water (these being known as blowing catalysts).

The corresponding catalysts are known per se, and perform in different ways in respect of the abovementioned three reactions. They can thus be allocated to one or more of the abovementioned types according to performance. The person skilled in the art is moreover aware that reactions other than the abovementioned reactions can also occur.

Corresponding catalysts can be characterized inter alia on the basis of their gel to blowing ratio, as is known by way of example from Polyurethane [Polyurethanes], 3rd edition, G. Oertel, Hanser Verlag, Munich, 1993, pp. 104 to 110.

To the extent that no component (a3), i.e. no water, is used, preferred catalysts have significant activity with regard to the trimerization process. This has an advantageous effect on the homogeneity of the network structure, resulting in particularly advantageous mechanical properties.

To the extent that water is used as component (a3), preferred catalysts (a4) have a balanced gel to blowing ratio, so that the reaction of component (a1) with water is not excessively accelerated, with an adverse effect on the network structure, and simultaneously a short gelling time is obtained, and therefore the demolding time is advantageously small. Preferred catalysts simultaneously have significant activity in respect of trimerization. This has an advantageous effect on the homogeneity of the network structure, giving particularly advantageous mechanical properties.

The catalysts can be a monomer unit (incorporable catalyst) or can be non-incorporable.

It is advantageous to use the smallest effective amount of component (a4). It is preferable to use amounts of from 0.01 to 5 parts by weight, in particular from 0.1 to 3 parts by weight, particularly preferably from 0.2 to 2.5 parts by weight, of component (a4), based on a total of 100 parts by weight of components (a1), (a2), and (a3).

Catalysts preferred for the purposes of component (a4) are selected from the group consisting of primary, secondary, and tertiary amines, triazine derivatives, organometallic compounds, metal chelates, quaternary ammonium salts, ammonium hydroxides, and also the hydroxides, alkoxides, and carboxylates of alkali metals and of alkaline earth metals.

Suitable catalysts are in particular strong bases, for example quaternary ammonium hydroxides, e.g. tetraalkylammonium hydroxides having from 1 to 4 carbon atoms in the alkyl moiety and benzyltrimethylammonium hydroxide, alkali metal hydroxides, e.g. potassium hydroxide or sodium hydroxide, and alkali metal alkoxides, e.g. sodium methoxide, potassium ethoxide and sodium ethoxide, and potassium isopropoxide.

Further suitable trimerization catalysts are, in particular, alkali metal salts of carboxylic acids, e.g. potassium formate, sodium acetate, potassium acetate, caesium acetate, ammonium acetate, potassium propionate, potassium sorbate, potassium 2-ethylhexanoate, potassium octanoate, potassium trifluoroacetate, potassium trichloroacetate, sodium chloroacetate, sodium dichloroacetate, sodium trichloroacetate, potassium adipate, potassium benzoate, sodium benzoate, alkali metal salts of saturated and unsaturated long-chain fatty acids having from 10 to 20 carbon atoms, and optionally lateral OH groups.

Other suitable catalysts are in particular N-hydroxyalkyl quaternary ammonium carboxylates, e.g. trimethylhydroxypropylammonium formate.

Examples of suitable organophosphorus compounds, in particular oxides of phospholenes, are 1-methylphospholene oxide, 3-methyl-1-phenylphospholene oxide, 1-phenylphospholene oxide, 3-methyl-1-benzyl phospholene oxide.

Organometallic compounds are known per se to the person skilled in the art in particular as gel catalysts and are likewise suitable as catalysts (a4). Organotin compounds, such as tin 2-ethylhexanoate and dibutyltin dilaurate are preferred for the purposes of component (a4). Preference is further given to metal acetylacetonates, in particular zinc acetylacetonate.

Tertiary amines are known per se to the person skilled in the art as gel catalysts and as trimerization catalysts. Tertiary amines are particularly preferred as catalysts (a4). Preferred tertiary amines are in particular N,N-dimethylbenzylamine, N,N′-dimethylpiperazine, N,N-dimethylcyclohexylamine, N,N′,N″-tris(dialkylaminoalkyl)-s-hexahydrotriazines, e.g. N,N′,N″-tris(dimethylaminopropyl)-s-hexahydrotriazine, tris(dimethylaminomethyl)phenol, bis(2-dimethylaminoethyl) ether, N,N,N,N,N-pentamethyldiethylenetriamine, methylimidazole, dimethylimidazole, aminopropylimidazole, dimethylbenzylamine, 1,6-diazabicyclo[5.4.0]undec-7-ene, triethylamine, triethylenediamine (IUPAC: 1,4-diazabicyclo[2,2,2]octane), dimethylaminoethanolamine, dimethylaminopropylamine, N,N-dimethylaminoethoxyethanol, N,N,N-trimethylaminoethylethanolamine, triethanolamine, diethanolamine, triisopropanolamine, and diisopropanolamine, methyldiethanolamine, butyldiethanolamine, and hydroxyethylaniline.

Catalysts particularly preferred for the purposes of component (a4) are selected from the group consisting of N,N-dimethylcyclohexylamine, bis(2-dimethylaminoethyl) ether, N,N,N,N,N-pentamethyldiethylenetriamine, methylimidazole, dimethylimidazole, aminopropylimidazole, dimethylbenzylamine, 1,6-diazabicyclo[5.4.0]undec-7-ene, trisdimethylaminopropylhexahydrotriazine, triethylamine, tris(dimethylaminomethyl)phenol, triethylenediamine (diazabicyclo[2,2,2]octane), dimethylaminoethanolamine, dimethylaminopropylamine, N,N-dimethylaminoethoxyethanol, N,N,N-trimethylaminoethylethanolamine, triethanolamine, diethanolamine, triisopropanolamine, diisopropanolamine, methyldiethanolamine, butyldiethanolamine, hydroxyethylaniline, metal acetylacetonates, acetates, propionates, sorbates, ethylhexanoates, octanoates and benzoates.

The use of the catalysts (a4) preferred for the purposes of the present invention leads to porous materials with improved mechanical properties, in particular to improved compressive strength. Use of the catalysts (a4) moreover reduces the gelling time, i.e. accelerates the gelling reaction, without any adverse effect on other properties.

Solvent

The organic aerogels or xerogels used in the invention are produced in the presence of a solvent.

For the purposes of the present invention, the term solvent comprises liquid diluents, i.e. not only solvents in the narrower sense but also dispersion media. The mixture can in particular be a genuine solution, a colloidal solution, or a dispersion, e.g. an emulsion or suspension. It is preferable that the mixture is a genuine solution. The solvent is a compound that is liquid under the conditions of the step (a), preferably an organic solvent.

Solvent used can in principle comprise an organic compound or a mixture of a plurality of compounds, where the solvent is liquid under the temperature conditions and pressure conditions under which the mixture is provided (abbreviated to: solution conditions). The constitution of the solvent is selected in such a way that the solvent is capable of dissolving or dispersing, preferably dissolving, the organic gel precursor. For the purposes of the preferred process described above for producing the organic aerogels or xerogels, preferred solvents are those which are a solvent for the organic gel precursor (A), i.e. those which dissolve the organic gel precursor (A) completely under reaction conditions.

The initial reaction product of the reaction in the presence of the solvent is a gel, i.e. a viscoelastic chemical network swollen by the solvent. A solvent which is a good swelling agent for the network formed generally leads to a network with fine pores and with small average pore diameter, whereas a solvent which is a poor swelling agent for the resultant gel generally leads to a coarse-pored network with large average pore diameter.

The selection of the solvent therefore affects the desired pore size distribution and the desired porosity. The selection of the solvent is generally also carried out in such a way as very substantially to avoid precipitation or flocculation due to formation of a precipitated reaction product during or after step (a) of the process of the invention.

When a suitable solvent is selected, the proportion of precipitated reaction product is usually smaller than 1% by weight, based on the total weight of the mixture. The amount of precipitated product formed in a particular solvent can be determined gravimetrically, by filtering the reaction mixture through a suitable filter prior to the gel point.

Solvents that can be used are those known from the prior art to be solvents for isocyanate-based polymers. Preferred solvents here are those which are a solvent for components (a1), (a2), and, where relevant, (a3), i.e. those which substantially completely dissolve the constituents of components (a1), (a2), and, where relevant, (a3) under reaction conditions. It is preferable that the solvent is inert to component (a1), i.e. not reactive thereto.

Examples of solvents that can be used are ketones, aldehydes, alkyl alkanoates, amides, such as formamide and N-methylpyrrolidone, sulfoxides, such as dimethyl sulfoxide, aliphatic and cycloaliphatic halogenated hydrocarbons, halogenated aromatic compounds, and fluorine-containing ethers. It is also possible to use mixtures made of two or more of the abovementioned compounds.

Acetals can also be used as solvents, in particular diethoxymethane, dimethoxymethane, and 1,3-dioxolane.

Dialkyl ethers and cyclic ethers are also suitable as solvent. Preferred dialkyl ethers are in particular those having from 2 to 6 carbon atoms, in particular methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl tert-butyl ether, ethyl-n-butyl ether, ethyl isobutyl ether, and ethyl tert-butyl ether. Particularly preferred cyclic ethers are tetrahydrofuran, dioxane, and tetrahydropyran.

Other preferred solvents are alkyl alkanoates, in particular methyl formate, methyl acetate, ethyl formate, butyl acetate, and ethyl acetate. Preferred halogenated solvents are described in WO 00/24799, page 4, line 12 to page 5, line 4.

Aldehydes and/or ketones are preferred solvents. Aldehydes or ketones suitable as solvents are particularly those corresponding to the general formula R²—(CO)—R¹, where R¹ and R² are hydrogen or alkyl groups having 1, 2, 3 or 4 carbon atoms. Suitable aldehydes or ketones are in particular acetaldehyde, propionaldehyde, n-butyraldehyde, isobutyraldehyde, 2-ethylbutyraldehyde, valeraldehyde, isopentaldehyde, 2-methylpentaldehyde, 2-ethylhexaldehydes, acrolein, methacrolein, crotonaldehyde, furfural, acrolein dimer, methacrolein dimer, 1,2,3,6-tetrahydrobenzaldehyde, 6-methyl-3-cyclohexenaldehyde, cyanacetaldehyde, ethyl glyoxylate, benzaldehyde, acetone, diethyl ketone, methyl ethyl ketone, methyl isobutyl ketone, methyl n-butyl ketone, ethyl isopropyl ketone, 2-acetylfuran, 2-methoxy-4-methylpentan-2-one, cyclohexanone, and acetophenone. The abovementioned aldehydes and ketones can also be used in the form of mixtures. Particular preference is given, as solvents, to ketones and aldehydes having alkyl groups having up to 3 carbon atoms per substituent. Ketones of the general formula R¹(CO)R² are very particularly preferred, where R¹ and R² are mutually independently selected from alkyl groups having from 1 to 3 carbon atoms. In one first preferred embodiment, the ketone is acetone. In another preferred embodiment, at least one of the two substituents R¹ and/or R² comprises an alkyl group having at least 2 carbon atoms, in particular methyl ethyl ketone. Use of the abovementioned particularly preferred ketones in combination with the process of the invention gives porous materials with particularly small average pore diameter. Without any intention of restriction, it is believed that the pore structure of the resultant gel is particularly fine because of the relatively high affinity of the abovementioned particularly preferred ketones.

In many instances, particularly suitable solvents are obtained by using a mixture of two or more compounds which are selected from the abovementioned solvents and which are completely miscible with one another.

It is preferable that components (a1), (a2), and, where relevant, (a3) and, where relevant, (a4), and the solvent are provided in appropriate form prior to the reaction in step (a) of the process of the invention.

It is preferable that components (a1) on the one hand and (a2) and, where relevant, (a3) and, where relevant, (a4) on the other hand are provided separately, in each case in a suitable portion of the solvent Separate provision permits ideal monitoring or control of the gelling reaction prior to and during the mixing process.

To the extent that water is used as component (a3), it is particularly preferable to provide component (a3) separately from component (a1). This avoids reaction of water with component (a1) with formation of networks in the absence of component (a2). Otherwise, the premixing of water with component (a1) leads to less advantageous properties in respect of the homogeneity of the pore structure and the thermal conductivity of the resultant materials.

The mixture(s) provided prior to conduct of step (a) can also comprise, as further constituents, conventional auxiliaries known to the person skilled in the art. Mention may be made by way of example of surfactant substances, nucleating agents, oxidation stabilizers, lubricants and demolding aids, dyes, and pigments, stabilizers, e.g. with respect to hydrolysis, light, heat, or discoloration, inorganic and/or organic fillers, reinforcing agents, and biocides.

Further details concerning the abovementioned auxiliaries and additives can be found in the technical literature, e.g. in Plastics Additives Handbook, 5th edition, H. Zweifel, ed. Hanser Publishers, Munich, 2001, pages 1 and 41-43.

In order to carry out the reaction in step (a) of the process, it is first necessary to produce a homogeneous mixture of the components provided prior to the reaction in step (a).

The components reacted for the purposes of step (a) can be provided in a conventional manner. It is preferable that a stirrer or other mixing apparatus is used for this purpose, in order to achieve good and rapid mixing. In order to avoid defects in the mixing process, the period necessary for producing the homogeneous mixture should be small in relation to the period within which the gelling reaction leads to the at least partial formation of a gel. The other mixing conditions are generally not critical, and by way of example the mixing process can be carried out at from 0 to 100° C. and at from 0.1 to 10 bar (absolute), in particular by way of example at room temperature and atmospheric pressure. Once a homogeneous mixture has been produced, the mixing apparatus is preferably switched off.

The gelling reaction involves a polyaddition reaction, in particular a polyaddition reaction of isocyanate groups and amino or hydroxy groups.

For the purposes of the present invention, a gel is a crosslinked system based on a polymer in contact with a liquid (terms used being solvogel or lyogel, or if water is used as liquid: aquagel or hydrogel). The polymer phase here forms a continuous three-dimensional network.

For the purposes of step (a) of the process, the gel is usually produced via standing, i.e. simply by allowing the container, reaction vessel, or reactor containing the mixture (termed gelling apparatus below) to stand. It is preferable that during the gelling (gel formation) process the mixture undergoes no further stirring or mixing, because this could inhibit formation of the gel. It has proven advantageous to cover the mixture during the gelling process or to seal the gelling apparatus.

The gelling process is known per se to the person skilled in the art and is described by way of example at page 21, line 19 to page 23, line 13 in WO 2009/027310.

In principle, any solvent can be used as long as it is miscible with carbon dioxide or has a sufficient boiling point which allows for removal of the solvent from the resulting gel. Generally, the solvent will be a low molecular organic compound, i.e. an alcohol having 1 to 6 carbon atoms, preferably 2 to 4, although other liquids known in the art can be used. Possible solvents are, for example, ketones, aldehydes, alkyl alkanoates, amides such as formamide, N-methylpyrollidone, N-ethylpyrollidone, sulfoxides such as dimethyl sulfoxide, aliphatic and cycloaliphatic halogenated hydrocarbons, halogenated aromatic compounds and fluorine-containing ethers. Mixtures of two or more of the abovementioned compounds are likewise possible. Examples of other useful liquids include but are not limited to: ethyl acetate, ethyl acetoacetate, acetone, dichloromethane, iso-propanol, methylethylketone, tetrahydrofurane, propylenecarbonate, and the like.

Further possibilities of solvents are acetals, in particular diethoxymethane, dimethoxymethane and 1,3-dioxolane.

Dialkyl ethers and cyclic ethers are likewise suitable as solvent. Preferred dialkyl ethers are, in particular, those having from 2 to 6 carbon atoms, in particular methyl ethyl ether, diethyl ether, methyl propyl ether, methyl isopropyl ether, propyl ethyl ether, ethyl isopropyl ether, dipropyl ether, propyl isopropyl ether, diisopropyl ether, methyl butyl ether, methyl isobutyl ether, methyl t-butyl ether, ethyl n-butyl ether, ethyl isobutyl ether and ethyl t-butyl ether. Preferred cyclic ethers are, in particular, tetrahydrofuran, dioxane and tetrahydropyran.

Aldehydes and/or ketones are particularly preferred as solvent. Aldehydes or ketones suitable as solvent are, in particular, those corresponding to the general formula R²—(CO)—R¹, where R¹ and R² are each hydrogen or an alkyl group having 1, 2, 3, 4, 5, 6 or 7 carbon atoms. Suitable aldehydes or ketones are, in particular, acetaldehyde, propionaldehyde, n-butyraldehyde, isobutyraldehyde, 2-ethylbutyraldehyde, valeraldehyde, isopentaldehyde, 2-methylpentaldehyde, 2-ethylhexaldehyde, acrolein, methacrolein, crotonaldehyde, furfural, acrolein dimer, methacrolein dimer, 1,2,3,6-tetrahydrobenzaldehyde, 6-methyl-3-cyclohexenaldehyde, cyanoacetaldehyde, ethyl glyoxylate, benzaldehyde, acetone, diethyl ketone, methyl ethyl ketone, methyl isobutyl ketone, methyl n-butyl ketone, methyl pentylketone, dipropyl ketone, ethyl isopropyl ketone, ethyl butyl ketone, diisobutylketone, 5-methyl-2-acetyl furan, 2-acetylfuran, 2-methoxy-4-methylpentan-2-one, 5-methylheptan-3-one, 2-heptanone, octanone, cyclohexanone, cyclopentanone, and acetophenone. The abovementioned aldehydes and ketones can also be used in the form of mixtures. Ketones and aldehydes having alkyl groups having up to 3 carbon atoms per substituent are preferred as solvent.

Further preferred solvents are alkyl alkanoates, in particular methyl formate, methyl acetate, ethyl formate, isopropyl acetate, butyl acetate, ethyl acetate, glycerine triacetate and ethyl acetoacetate. Preferred halogenated solvents are described in WO 00/24799, page 4, line 12 to page 5, line 4.

Further suitable solvents are organic carbonates such as for example dimethyl carbonate, diethyl carbonate, ethylene carbonate, propylene carbonate or butylene carbonate.

In many cases, particularly suitable solvents are obtained by using two or more completely miscible compounds selected from the abovementioned solvents.

The process of the present invention can also comprise further steps, for example suitable treatment steps.

The product obtained in the process of the present invention is a porous material with a porosity of preferably at least 70 vol. %, in particular an aerogel. The porous material may be a powder or a monolithic block. The porous material may be an organic porous material or an inorganic porous material.

In further embodiments, the porous material comprises average pore diameters from about 2 nm to about 2000 nm. In additional embodiments, the average pore diameters of dried gel materials may be about 4 nm, about 6 nm, about 8 nm, about 10 nm, about 12 nm, about 14 nm, about 16 nm, about 18 nm, about 20 nm, about 25 nm, about 30 nm, about 35 nm, about 40 nm, about 45 nm, about 50 nm, about 60 nm, about 70 nm, about 80 nm, about 90 nm, about 100 nm, about 200 nm, about 500 nm, about 1000 nm, or about 2000 nm. The size distribution of the pores of the porous material may be monomodal or multimodal according to the present invention.

In the context of the present invention, the surface area, the pore sizes as well as the pore volumes were measured by BET in accordance with ISO 9277:2010 unless otherwise noted. This International Standard specifies the determination of the overall specific external and internal surface area of disperse (e.g. nano-powders) or porous solids by measuring the amount of physically adsorbed gas according to the Brunauer, Emmett and Teller (BET) method. It takes account of the International Union for Pure and Applied Chemistry (IUPAC) recommendations of 1984 and 1994.

According to a further aspect, the present invention is also directed to a porous material, which is obtained or obtainable by the process according to the present invention.

The porous materials obtained or obtainable by the process of the present invention are suitable for different applications.

The present invention is also directed to the use of porous materials as disclosed above or a porous material obtained or obtainable according to a process as disclosed above as thermal insulation material or as core material for vacuum insulation panels.

The invention also relates to construction materials and vacuum insulation panels comprising the porous materials and the use of porous materials for thermal insulation. Preferably, the materials obtained according to the invention are used for thermal insulation especially in buildings, or for cold insulation, particularly in mobile, transportation applications or in stationary applications, for example in cooling devices or for mobile applications.

For mechanical reinforcement for certain applications fibers can be used as additives.

The materials used in thermal insulation materials are preferably used in the following fields of application: as insulation in hollow blocks, as core insulation for multi-shell building blocks, as core insulation for vacuum insulation panels (VIP), as the core insulation for exterior insulation systems, as insulation for cavity wall works, especially in the context of loose-fill insulation.

A further object of the present invention are molded articles, building blocks or modules, building systems and building composites which contain or consist of the porous material according to the present invention. Another object of the present invention are vacuum insulation panels which contain porous materials according to the present invention. Furthermore, the thermal insulation material and the porous materials are in particular suitable for the insulation of extruded hollow profiles, particularly as the core material for the insulation in window frames.

The thermal insulation material is for example an insulation material which is used for insulation in the interior or the exterior of a building or as wall cavity insulation. The porous material according to the present invention can advantageously be used in thermal insulation systems such as for example composite materials.

According to a further aspect, the present invention is also directed to the use of porous material, in particular an inorganic or organic porous material, as disclosed above or a porous material, in particular an inorganic porous material, obtained or obtainable by a process as disclosed above as catalyst support, for the preparation of sensors as additive for food applications or for medical, pharmaceutical and cosmetic applications. It can be preferable to use porous material based on biopolymers, more specifically polysaccharides, for some applications. Within cosmetic applications the porous material, in particular an inorganic or organic porous material, obtained or obtainable by the process of the present invention can be used for example as deodorant active agent which is one method for the treatment of human body odors. These can be provided in all forms which can be envisaged for a deodorant composition. It can be a lotion, dispersion as a spray or aerosol; a cream, in particular dispensed as a tube or as a grating; a fluid gel, dispensed as a roll-an or as a grating; in the form of a stick; in the form of a loose or compact powder, and comprising, in this respect, the ingredients generally used in products of this type which are well known to a person skilled in the art, with the proviso that they do not interfere with the aerogels in accordance with the invention.

The present invention is also directed to the use of porous materials as disclosed above or a porous material obtained or obtainable according to a process as disclosed above as thermal insulation material or for vacuum insulation panels. The thermal insulation material is for example insulation material which is used for insulation in the interior or the exterior of a building. The porous material according to the present invention can advantageously be used in thermal insulation systems such as for example composite materials.

According to a further embodiment, the present invention therefore is directed to the use of porous materials as disclosed above, wherein the porous material is used in interior or exterior thermal insulation systems.

Summarizing, the present invention includes the following embodiments, wherein these include the specific combinations of embodiments as indicated by the respective interdependencies defined therein.

Embodiment 1: Method for manufacturing a plurality of bodies made of a porous material derived from precursors of the porous material in a sol-gel process, comprising:
(i) filling precursors of the porous material into a mold defining the shape of the body, wherein the precursors include at least two reactive components (CA, CB) and a solvent (S), and forming a gel body,
(ii) repeating step (i) so as to form a plurality of gel bodies,
(iii) removing the gel bodies from the mold after a predetermined time in which the gel bodies are formed from the precursors of the porous material,
(iv) arranging the gel bodies adjacent to one another,
(v) providing a spacer between two adjacent gel bodies so as to provide a clearance therebetween,
(vi) removing the solvent (S) from the gel bodies.

Embodiment 2: Method according to embodiment 1, wherein the spacer is a grid assembly comprising a first grid and a second grid connected to one another, wherein the first grid comprising first openings and the second grid comprises second openings, wherein the first openings and second openings are shifted to one another.

Embodiment 3: Method according to embodiment 2, wherein the grid assembly comprises a thickness of 1.0 mm to 4.0 mm, preferably 1.25 mm to 3.5 mm and more preferably 1.5 mm to 2.5 mm.

Embodiment 4: Method according to embodiment 2 or 3, wherein the first openings and/or the second openings are arranged in a regular or irregular pattern.

Embodiment 5: Method according to any one of embodiments 2 to 4, wherein the first openings and/or the second openings comprise identical or different opening areas.

Embodiment 6: Method according to any one of embodiments 2 to 5, wherein the first openings and/or the second openings comprise identical or different shapes.

Embodiment 7: Method according to any one of embodiments 2 to 6, wherein the first openings and/or the second openings comprise a circular, oval, elliptical, polygonal, polygonal including rounded edges, rectangular or square shape.

Embodiment 8: Method according to any one of embodiments 2 to 7, further comprising at least partially providing surfaces of the first grid and/or second grid with a coating made of a material being electrically dissipative and non-sticky to the gel bodies.

Embodiment 9: Method according to any one of embodiments 2 to 8, wherein a total opening area of the first and second openings is 40% to 95% of a facing outer surface of a body.

Embodiment 10: Method according to embodiment 1, further comprising integrally, preferably monolithically, forming each of the gel bodies with the spacer.

Embodiment 11: Method according to embodiment 10, wherein the spacer includes a plurality of protrusions protruding from at least one surface of the gel bodies.

Embodiment 12: Method according to embodiment 11, further comprising forming the protrusions only on one surface of each of the gel bodies, wherein the gel bodies are arranged adjacent to one another such that the surface including the protrusions of one of the gel bodies faces a surface without protrusions of the respective adjacent body.

Embodiment 13: Method according to embodiment 11 or 12, wherein each of the protrusions comprises circular cross-sectional shape with a diameter of 1.0 to 5.0 mm, preferably 1.25 mm to 4.0 mm and more preferably 1.5 mm to 2.5 mm.

Embodiment 14: Method according to any one of embodiments 10 to 13, wherein the protrusions are arranged in a regular or irregular pattern.

Embodiment 15: Method according to any one of embodiments 10 to 14, wherein the protrusions have identical or different shapes.

Embodiment 16: Method according to any one of embodiments 10 to 15, wherein the protrusions have a height of 0.1 mm to 20.0 mm, preferably 0.5 mm to 5.0 mm and more preferably 1.0 mm to 3.0 mm.

Embodiment 17: Method according to any one of embodiments 10 to 16, wherein the protrusions are arranged such that a minimum distance between outer surfaces of adjacent protrusions is 0.1 mm.

Embodiment 18: Method according to any one of embodiments 10 to 17, wherein the protrusions are formed as truncated cones.

Embodiment 19: Method according to any one of embodiments 10 to 18, further comprising removing the protrusions after removing the solvent (S) from the gel bodies.

Embodiment 20: Method according to any one of embodiments 1 to 19, wherein the gel bodies are formed as slabs having a cuboid, cylindrical or polygonal shape, wherein gel bodies are arranged such that side surfaces of the cuboid, cylindrical or polygonal shape having the greatest surface area are oriented substantially perpendicular with respect to a direction of gravity.

Embodiment 21: Method according to any one of embodiments 1 to 19, wherein the gel bodies are formed as slabs having a cuboid, cylindrical or polygonal shape, wherein the gel bodies are arranged such that side surfaces of the cuboid, cylindrical or polygonal shape having the greatest surface area are oriented substantially parallel with respect to a direction of gravity.

Embodiment 22: Method according to embodiment 20 or 21, wherein the gel bodies are arranged such that edges of the cuboid, cylindrical or polygonal shape having the greatest dimension are oriented substantially perpendicular with respect to a direction of gravity.

Embodiment 23: Method according to any one of embodiments 1 to 22, wherein the gel bodies are formed as slabs, wherein the slabs comprise a length of at least 10 cm and a width of at least 10 cm.

Embodiment 24: Method according to any one of embodiments 1 to 23, wherein the gel bodies are formed as slabs, wherein the slabs comprise a thickness of at least 0.5 mm.

Embodiment 25: Method according to embodiment 1, wherein the spacer is a grid comprising grid openings.

Embodiment 26: Method according to embodiment 25, wherein the grid openings comprise identical or different opening areas.

Embodiment 27: Method according to any one of embodiments 25 to 26, wherein the grid openings are arranged in a regular or irregular pattern.

Embodiment 28: Method according to any one of embodiments 25 to 27, wherein the grid comprises struts defining the openings, wherein the struts comprise a width of 1.0 mm to 5.0 mm, preferably 1.25 mm to 4.5 mm and more preferably 1.5 mm to 4.0 mm.

Embodiment 29: Method according to any one of embodiments 25 to 28, wherein the gel bodies are formed as slabs having a cuboid, cylindrical or polygonal shape, wherein the gel bodies are arranged such that side surfaces of the cuboid, cylindrical or polygonal shape having the greatest surface area are oriented substantially perpendicular with respect to a direction of gravity.

Embodiment 30: Method according to any one of embodiments 25 to 29, further comprising at least partially providing surfaces of the grid with a coating made of a material being electrically dissipative and non-sticky to the gel bodies.

Embodiment 31: Method according to any one of embodiments 25 to 30, wherein removing the solvent from the body is performed by means of supercritical drying.

Embodiment 32: Method according to any one of embodiments 25 to 30, wherein the grid is configured to carry a body and to support another grid disposed thereon without the body being engaged by the other grid.

Embodiment 33: Method according to embodiment 32, wherein the grid comprises an outer rim, wherein the outer rim is configured to support another grid disposed thereon without the body being engaged by the other grid.

Embodiment 34: Method according to any one of embodiments 1 to 24 or 32 to 33, wherein removing the solvent from the body is performed by means of supercritical drying or convective drying.

Embodiment 35: A body made of a porous material, which is obtained or obtainable by the process according to any one of embodiments 1 to 34.

Embodiment 36: The use of a body according to embodiment 35 or a body obtained or obtainable by the process according to any of embodiments 1 to 34 as thermal insulation material or for vacuum insulation panels.

Embodiment 37: The use according to embodiment 36, wherein the body is used in interior or exterior thermal insulation systems.

### SHORT DESCRIPTION OF THE FIGURES

Further features and embodiments of the invention will be disclosed in more detail in the subsequent description, particularly in conjunction with the dependent claims. Therein the respective features may be realized in an isolated fashion as well as in any arbitrary feasible combination, as a skilled person will realize. The embodiments are schematically depicted in the figures. Therein, identical reference numbers in these figures refer to identical elements or functionally identical elements.

In the Figures:

FIG. 1 shows a flow chart of the method according to the present invention;

FIG. 2 shows a perspective view of a spacer used with a first embodiment of the disclosed method;

FIG. 3 shows an enlarged view of a portion of the spacer of FIG. 2;

FIG. 4 shows a perspective view of a plurality of bodies arranged according to a first orientation;

FIG. 5 shows a perspective view of a plurality of bodies arranged according to a second orientation;

FIG. 6 shows a perspective view of a mold used with a second embodiment of the disclosed method;

FIG. 7 shows a schematical flow chart of the second embodiment of the disclosed method; and

FIGS. 8A to 8F show perspective views of different spacers used with a third embodiment of the disclosed method.

### DETAILED DESCRIPTION

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “particularly”, “more particularly”, “specifically”, “more specifically” or similar terms are used in conjunction with additional/alternative features, without restricting alternative possibilities. Thus, features introduced by these terms are additional/alternative features and are not intended to restrict the scope of the claims in any way. The invention may, as the skilled person will recognize, be performed by using alternative features. Similarly, features introduced by “in an embodiment of the invention” or similar expressions are intended to be additional/alternative features, without any restriction regarding alternative embodiments of the invention, without any restrictions regarding the scope of the invention and without any restriction regarding the possibility of combining the features introduced in such way with other additional/alternative or non-additional/alternative features of the invention.

Further, it shall be noted that the terms “first”, “second” and “third” are used to exclusively facilitate to differ between the respective constructional members or elements and shall not be construed to define a certain order or importance.

The term “mold” as used herein refers to a hollowed-out block or container that is configured to be filled with a liquid or pliable material provided by precursors of a sol gel provided by precursors of a sol gel. Particularly, the sol-gel process is carried out within the mold. During the sol-gel process the precursors form a sol which subsequently starts to gel. Thus, the liquid hardens or sets inside the mold, adopting its shape defined by the interior volume thereof. The mold is basically used to carry out the sol-gel process. However, it is to be noted that the solvent may be removed from the thus formed gel with the gel remaining within the mold or with the gel removed from the mold. In the present invention, the mold may consist of more than one part, wherein the interior volume is defined by a lower part.

The term “sol gel process” as used herein refers to a method for producing solid materials from small molecules. In the present case, the method is used for the fabrication of porous materials such as aerogels, xerogels and/or kryogels. The process involves conversion of monomers as precursors into a colloidal solution, the so-called sol, that subsequently reacts to an integrated network, the so-called gel, of either discrete particles or network polymers. In this chemical procedure, the sol gradually evolves towards the formation of a gel-like diphasic system containing both a liquid phase and solid phase whose morphologies range from discrete particles to continuous polymer networks. This gel-like diphasic system is called gel. Particularly, the gel encapsulates or surrounds the solvent within pores which are connected to one another, i.e. the pores form an interpenetrating network. Removal of the remaining liquid phase, i.e. the solvent, requires a drying process, which is typically accompanied by a certain amount of shrinkage and densification. The rate at which the solvent can be removed is ultimately determined by the distribution of porosity in the gel. The ultimate microstructure of the final component will clearly be strongly influenced by changes imposed upon the structural template during this phase of processing.

The term “body” as used herein refers to a solid object formed by an identifiable collection of matter, which may be constrained by an identifiable boundary, and may move or may be moved as a unit by translation or rotation, in 3-dimensional space.

The term “porous” as used herein refers to material characteristics of having pores. As the solvent may be removed from the gel either with the gel being or remaining within the mold or after the gel is removed from the mold, the term “porous” covers both pores being filled with a liquid, particularly, the solvent, or a gas such as air. The pores may be connected to one another so as to form a type of network.

The term “coating” as used herein refers to a covering that is applied to the inner surfaces of the lower part of the mold. Particularly, the coating may be applied at least to those areas of the lower part intended to come into contact with the precursors of the porous material and the body made thereof. Needless to say, the coating may be applied to the total inner surfaces of the lower part defining the interior volume.

The term “electrically dissipative” as used herein refers to material characteristics, wherein electric charges are allowed to flow to ground but more slowly in a more controlled manner if compared to electrically conductive materials.

The term “non-sticky” as uses herein refers to characteristics wherein one part does not adhere to another part. Thus, both parts are in loose contact to one another. According to the present invention, the coating does not stick to the gel formed or resulting from the precursors filled into the mold. In case the solvent used with the sol gel process is removed with the gel being within the mold, the coating is configured not to stick to the thus formed body in order to allow the body being removed from the mold.

The terms “width” and “length” of the shape of the body as used herein refer to dimensions perpendicular to a height or thickness of the shape of the body.

The term “opening area” as used herein refers to the area of an opening defined by the boundary of the opening.

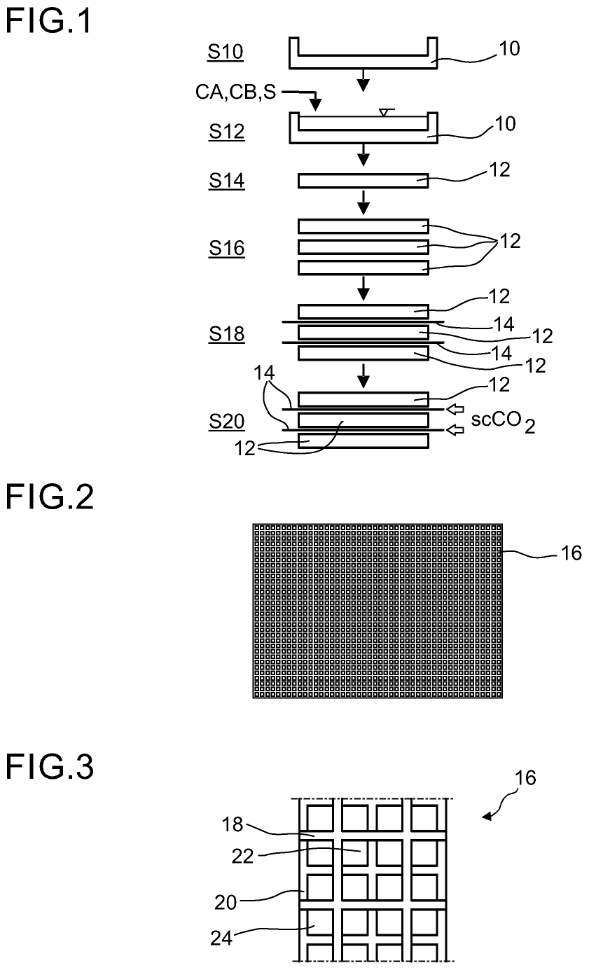

FIG. 1 shows a flow chart of a method for manufacturing a plurality of bodies made of a porous material derived from precursors of the porous material in a sol-gel process according to the present invention. FIG. 1 is to be understood as an explanation of the basic principle of the disclosed method. In step S10, a mold 10 is provided. The mold 10 defines the shape of a to be formed body 12. In step S12, precursors of the porous material are filled into the mold 10. The precursors include at least two reactive components CA, CB and a solvent S. The precursors of the porous material may be prepared as follows. A first reactive component CA and a solvent S are supplied to a first receiving tank. Further, a second reactive component CB and the solvent S are supplied to a second receiving tank. A predetermined amount of the first reactive component and solvent is supplied to a mixing device from the first receiving tank. For example, the predetermined amount is defined as a volumetric dosing by means of a first volumetric dosing device. A predetermined amount of the second reactive component and solvent is supplied to the mixing device from the second receiving tank. For example, the predetermined amount is defined as a volumetric dosing by means of a second volumetric dosing device. Optionally, a closed loop operation may be provided with the first receiving tank and the mixing device and/or with the second receiving tank and the mixing device. The precursors of the porous material are then filled into the mold 10 up to a predetermined amount. For example, the filling process is carried out by means of the mixing device. Particularly, the precursors are mixed by means of the mixing device before being filled into the lower part. The precursors may be filled into the mold 10 in an inert or ventilated region. For example, the filling is carried out in a carbon dioxide or nitrogen atmosphere or in a ventilated device similar to a laboratory hood. The mold 10 may be closed by a lid, particularly in a gas tight manner. Thereby, any solvent vapor is prevented from leaking from the mold 10. Then, the sol gel reaction from the two reactive components of the precursors takes place wherein the precursors gel. Thus, a gel body 12 is formed. After gelling, the gel is hardened or aged for a predetermined time such as at least 3 hours and preferably at least 8 hours in order to complete the gelation reaction and to exclude a negative impact on the further handling of the gel body 12 such as in case the gel body is not sufficiently hard. For example, the hardening or ageing process is carried out by means of a hardening device. After hardening, the body is formed.

Step 12 is repeated so as to form a plurality of gel bodies 12. Particularly, step S12 may be repeated any number of times as appropriate and depending on the respective application. The gel bodies 12 may be formed as slabs, wherein the slabs comprise a length of at least 10 cm and a width of at least 10 cm. For practical reasons, the upper limit for the length and/or the width may be 200 cm or even 100 cm. The slabs comprise a thickness of at least 0.5 mm. For practical reasons, the upper limit for the thickness may be 25.0 mm, 20.0 mm or 15.0 mm. Subsequently, in step S14, the gel bodies 12 are removed from the mold 10. With other words, the gel bodies 12 from each mold 10 or in case a single mold 10 is used, the gel bodies 12 are removed from the mold 10 in a subsequent order after a predetermined time in which the gel body/bodies 12 is/are formed from the precursors of the porous material. Further, the solvent S may be recycled or re-extracted by means of a re-extraction device.

In step S16, the gel bodies 12 are arranged adjacent to one another. In step S18, a spacer 14 is provided between two adjacent gel bodies 12 so as to provide a clearance therebetween. It has to be noted that steps S16 and S18 may be carried out at the same time. In step S20, the solvent S is removed from the gel bodies 12. The removing of the solvent S from the gel bodies 12 is performed by means of supercritical drying or convective drying. The removing may take place in an autoclave or oven. In the example shown in FIG. 1, the solvent S is removed by means of supercritical CO₂.

FIG. 2 shows a perspective view of a spacer 14 used with a first embodiment of the disclosed method. FIG. 3 shows an enlarged view of a portion of the spacer 14 of FIG. 2. The spacer 14 of the first embodiment is a grid assembly 16. The grid assembly 16 comprises a first grid 18 and a second grid 20 connected to one another. Particularly, the first grid 18 is disposed on top of the second grid 20. The first grid 18 comprises first openings 22. The second grid 20 comprises second opening 24. The first openings 22 and second openings 24 are shifted to one another. With other words, the first openings 22 and second openings 24 do not exactly overlap one another but only partially. Thus, the first and second openings create an open path in the plane of the two grids 18, 20 allowing the solvent S to flow therethrough. The first openings 22 and the second openings 24 are arranged in a regular pattern. The first openings 22 and the second openings 24 comprise identical opening areas. A total opening area of the first and second openings 22, 24 may be 40% to 95% of a facing outer surface of a body 12 such as 80%. The first openings 22 and the second openings 24 comprise identical shapes. In the example shown, the first openings 22 and the second openings 24 have a rectangular and square shape, respectively. The grid assembly 16 comprises a thickness of 1.0 mm to 4.0 mm, preferably 1.25 mm to 3.5 mm and more preferably 1.5 mm to 2.5 mm such as 2.0 mm. Surfaces of the first grid 18 and/or second grid 20 may be at least partially provided with a coating made of a material being electrically dissipative and non-sticky to the gel bodies 12.

The grid assembly 16 may be modified as follows. The first openings 22 and/or the second openings 24 may be arranged in an irregular pattern. The first openings 22 and/or the second openings 24 may comprise different opening areas. The first openings 22 and/or the second openings 24 may comprise different shapes. The first openings 22 and/or the second openings 24 may comprise a circular, oval, elliptical, polygonal or polygonal including rounded edges, shape.

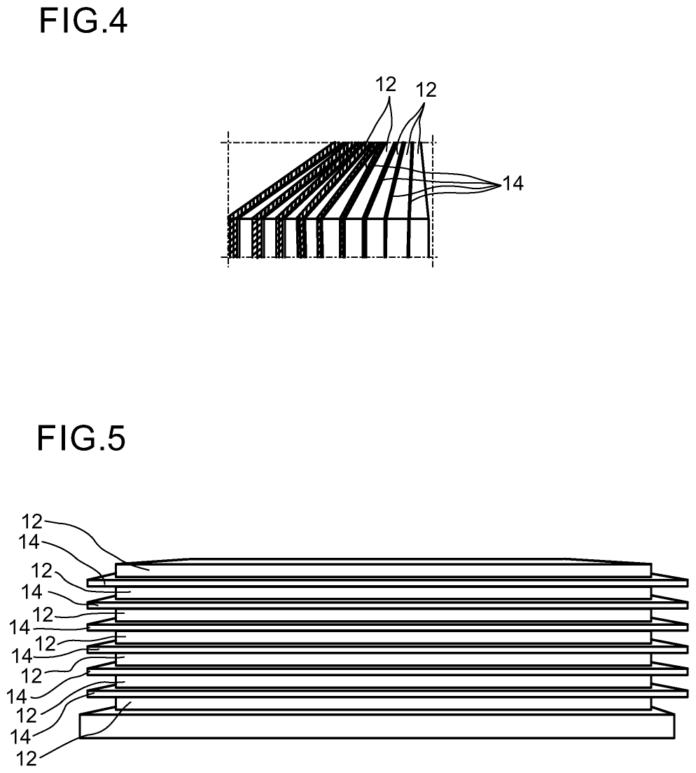

FIG. 4 shows a perspective view of a plurality of gel bodies 12 arranged according to a first orientation during the removal of the solvent in step S20. The gel bodies 12 are formed as slabs having a cuboid shape. In the first orientation, the gel bodies 12 removed from the mold 10 are arranged substantially vertical. With other words, the gel bodies 12 are arranged such that side surfaces of the cuboid shape having the greatest surface area are oriented substantially parallel with respect to a direction of gravity. Further, the gel bodies 12 are arranged such that edges of the cuboid shape having the greatest dimension are oriented substantially perpendicular with respect to a direction of gravity. As can be further seen in FIG. 4, spacers 14 as shown in FIGS. 2 and 3 are provided between adjacent gel bodies 12. Basically, the gel bodies 12 may alternatively be formed as slabs having a cylindrical or polygonal shape.

FIG. 5 shows a perspective view of a plurality of gel bodies 12 arranged according to a second orientation during the removal of the solvent in step S20. The gel bodies 12 are formed as slabs having a cuboid shape. In the second orientation, the gel bodies 12 removed from the mold 10 are arranged substantially horizontal. With other words, the gel bodies 12 are arranged such that side surfaces of the cuboid shape having the greatest surface area are oriented substantially perpendicular with respect to a direction of gravity. Further, the gel bodies 12 are arranged such that edges of the cuboid shape having the greatest dimension are oriented substantially perpendicular with respect to a direction of gravity. As can be further seen in FIG. 5, spacers 14 as shown in FIGS. 2 and 3 are provided between adjacent gel bodies 12. Basically, the gel bodies 12 may alternatively be formed as slabs having a cylindrical or polygonal shape. It has to be noted that the removing of the solvent with the horizontal arrangement of the gel slabs may take some more time than with the vertical arrangement of the gel slabs.

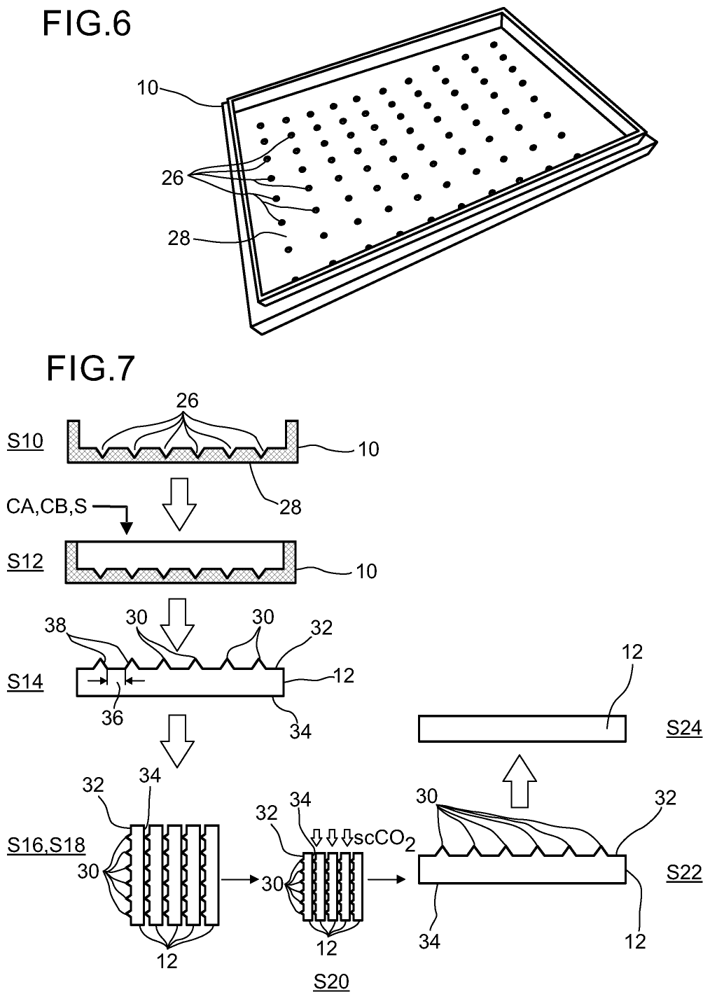

FIG. 6 shows a perspective view of a mold 10 used with a second embodiment of the disclosed method. The mold 10 used with the second embodiment of the disclosed method comprises a cuboid shape. Further, the mold 10 comprises recesses or indentations 26 in a bottom surface 28. The indentations 26 are arranged in a regular pattern and comprise a truncated cone shape. Hereinafter, the second embodiment of the disclosed method will be described in further detail.

FIG. 7 shows a schematical flow chart of the second embodiment of the disclosed method. Hereinafter, only the difference from the first embodiment of the disclosed method will be described in detail and identical or constructional members or method steps are indicated by like reference numerals and are only briefly described. In step S10, the mold 10 shown in FIG. 6 is provided. In step S12, the precursors of the porous material as described above are filled into the mold 10. The precursors also flow into the indentations 26 in the bottom surface 28 of the mold 10. In step S14, the gel bodies 12 are removed from the mold 10. With other words, the gel bodies 12 from each mold 10 or in case a single mold 10 is used, the gel bodies 12 are removed from the mold 10 in a sub-sequent order after a predetermined time in which the gel body/bodies 12 is/are formed from the precursors of the porous material. As the precursors have flowed into the indentations 26 in the bottom surface 28 of the mold 10, the gel bodies 12 are integrally and monolithically, respectively, formed with the spacer 14. Particularly, the spacer 14 includes a plurality of protrusions 30 protruding from at least one surface 32 of the gel bodies 12. The protrusions 30 are formed only on one surface 32 of each of the gel bodies 12. As the indentations 26 of the mold 10 are arranged in a regular pattern, also the protrusions 30 are arranged in a regular pattern. Particularly, the protrusions 30 are arranged such that a minimum distance 36 between outer surfaces 38 of adjacent protrusions 30 is 0.1 mm. The minimum distance 36 may defined at the transition of a protrusions 30 into the body 12. As the indentations 26 of the mold 10 are shaped as truncated cones, the protrusions 30 are formed as truncated cones. Further, the protrusions 30 have identical shapes. The protrusions 30 have a height 40 of 0.1 mm to 20.0 mm, preferably 0.5 mm to 5.0 mm and more preferably 1.0 mm to 3.0 mm such as 2.0 mm. Each of the protrusions 30 comprises circular cross-sectional shape with a diameter of 1.0 to 5.0 mm, preferably 1.25 mm to 4.0 mm and more preferably 1.5 mm to 2.5 mm such as 2.0 mm. In case of a cone or truncated cone shape, the diameter may be defined at the half of the height 40 or as an average value along the height 40.

In step S16, the gel bodies 12 are arranged adjacent to one another such that the surface 32 including the protrusions 30 of one of the gel bodies 12 faces a surface 34 without protrusions of the respective adjacent body 12. Thus, by arranging the gel bodies 12 adjacent to one another, the spacer 14 formed by the protrusions 30 is automatically provided between two adjacent gel bodies 12 so as to provide a clearance therebetween. With other words, steps S16 and step S18 are combined. In step S20, the solvent S is removed from the gel bodies 12 as described above, i.e. by means of convective or supercritical drying. In the example shown in FIG. 7, the solvent S is removed by means of supercritical CO₂. In step S24, the gel bodies 12 have been removed from the solvent S and are released from the adjacent arrangement. In step S24, the protrusions 30 may optionally be removed after removing the solvent S from the gel bodies 12.

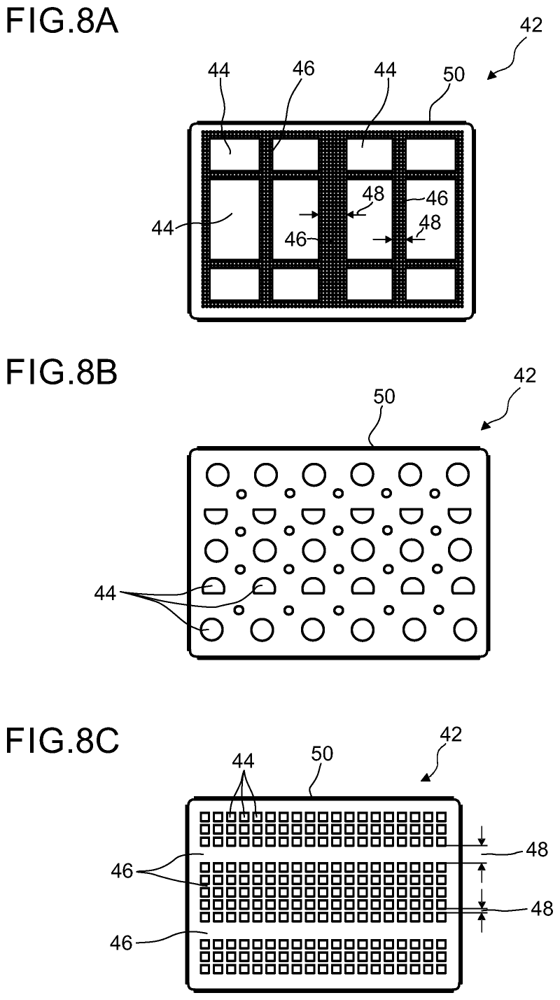

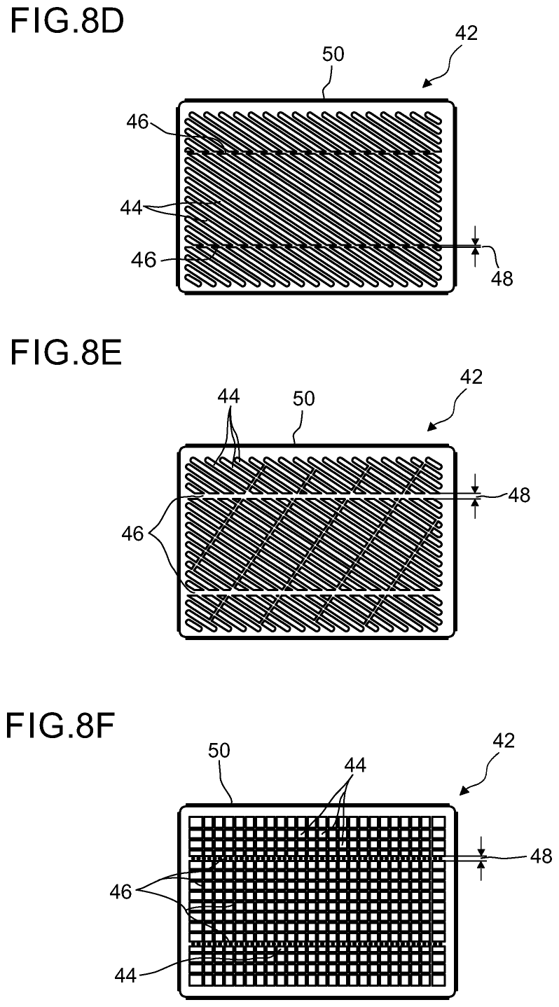

The bodies 12 may be modified as follows by modifying the mold 10 shown in FIG. 6. The protrusions 30 may be formed on two opposing surfaces of the gel bodies 12. The protrusions 30 may be arranged in an irregular pattern. The protrusions 30 may have different shapes. FIGS. 8A to 8F show perspective views of different spacers 14 used with a third embodiment of the disclosed method. According to FIGS. 8A to 8F, the spacer 14 is a grid 42 comprising grid openings 44. The grid 42 comprises struts 46 defining the grid openings 44. The struts 46 comprise a width 48 of 1.0 mm to 5.0 mm, preferably 1.25 mm to 4.5 mm and more preferably 1.5 mm to 4.0 mm. It has to be noted that the struts 46 of one and the same grid 42 may comprise different widths 50. The spacers 14 shown in FIGS. 8A to 8F are designed such that the grid 42 is configured to carry a body 12 and to support another grid 42 disposed thereon without the body 12 being engaged by the other grid 42. For this purpose, the grid 42 comprises an outer rim 50 configured to support another grid 42 disposed thereon without the body 12 being engaged by the other grid 42. The grids shown in FIGS. 8A to 8F are particularly designed for allowing to remove the solvent S by means of supercritical drying. Basically, the grids 42 shown in FIGS. 8A to 8F are configured to be horizontally arranged one on top of the other during the step of removing the solvent S similar to arrangement shown in FIG. 5. Thus, with the third embodiment, the gel bodies 12 are formed as slabs having a cuboid, cylindrical or polygonal shape, wherein the gel bodies 12 are arranged such that side surfaces of the cuboid, cylindrical or polygonal shape having the greatest surface area are oriented substantially perpendicular with respect to a direction of gravity. The surfaces of the grid 42 may be provided with a coating made of a material being electrically dissipative and non-sticky to the gel bodies 12. The grid openings 42 may comprise identical or different opening areas. The grid openings 44 may be arranged in a regular or irregular pattern. Hereinafter, further details of the grids 42 shown in FIGS. 8A to 8F will be described.

FIG. 8A shows a grid 42 having square shaped grid openings 44 of different sizes. Further, the struts 46 comprise different widths 48. Particularly, the grid 42 comprises two struts 46 having a width 48 larger than the remaining struts 46, such as by factor 2. Further, some of the grid openings 44 are formed in the struts 46 and adjacent the outer rim 50 and are smaller than the remaining grid openings 44.

FIG. 8B shows a grid 42 having grid openings 44 of different sizes and different shapes. Particularly, there are larger circular grid openings 44, smaller circular grid openings 44 and half rounded grid openings 44.

FIG. 8C shows a grid 42 having square shaped grid openings 44 of identical sizes. Further, the struts 46 comprise different widths 48. Particularly, the grid 42 comprises two struts 46 having a width 48 larger than the remaining struts 46, such as by factor 2.

FIG. 8D shows a grid 42 having grid openings 44 of different sizes. Particularly, the grid openings 44 are formed as long slots running diagonally. Further, the grid 42 comprises two struts 46 running parallel to one another and inclined with respect to the grid openings 44.

FIG. 8E shows a grid 42 similar to the grid shown in FIG. 8D. The grid 42 has grid openings 44 of different sizes. Particularly, the grid openings 44 are formed as long slots running diagonally. Further, the grid 42 comprises two struts 46 running parallel to one another and inclined with respect to the grid openings 44. If compared to the grid shown in FIG. 80, the struts 46 of the grid 42 shown in FIG. 8E comprise a larger width 48.

FIG. 8F shows a grid 42 similar to the grid 43 shown in FIG. 8C. The grid 42 has square shaped grid openings 44 of different sizes. Further, the struts 46 comprise different widths 48. Particularly, the grid 42 comprises two struts 46 having a width 48 larger than the remaining struts 46, such as by factor 2. These two struts 46 comprise grid openings 44 smaller than the remaining grid openings 44.

### CITED LITERATURE

WO 00/24799
WO 2009/027310
WO 2016/150684 A1
US 2005/0159497 A1

1: A method for manufacturing a plurality of bodies made of a porous material derived from precursors of the porous material in a sol-gel process, the method comprising:
(i) filling precursors of a porous material into a mold defining a shape of a body, wherein the precursors include at least two reactive components and a solvent, and forming a gel body,
(ii) repeating (i) so as to form a plurality of gel bodies,
(iii) removing the plurality of gel bodies from the mold after a predetermined time in which the plurality of gel bodies are formed from the precursors of the porous material,
(iv) arranging the plurality of gel bodies adjacent to one another,
(v) providing a spacer between two adjacent gel bodies so as to provide a clearance therebetween, and
(vi) removing the solvent from the plurality of gel bodies.

2: The method according to claim 1, wherein the spacer is a grid assembly comprising a first grid and a second grid connected to one another,
wherein the first grid comprises first openings and the second grid comprises second openings, wherein the first openings and the second openings are shifted relative to one another.

3: The method according to claim 2, wherein the grid assembly comprises a thickness of 1.0 mm to 4.0 mm, and/or
wherein the first openings and/or the second openings are arranged in a regular or irregular pattern, and/or
wherein the first openings and/or the second openings comprise identical or different opening areas, and/or
wherein the first openings and/or the second openings comprise identical or different shapes, and/or
wherein the first openings and/or the second openings comprise a circular, oval, elliptical, polygonal, polygonal including rounded edges, rectangular, or square shape, and/or
wherein the method further comprises at least partially providing surfaces of the first grid and/or the second grid with a coating made of a material being electrically dissipative and non-sticky to the plurality of gel bodies, and/or wherein a total opening area of the first openings and the second openings is 40% to 95% of a facing outer surface of one of the plurality of gel bodies.

4: The method according to claim 1, further comprising integrally forming each of the plurality of gel bodies with the spacer.

5: The method according to claim 4, wherein the spacer includes a plurality of protrusions protruding from at least one surface of the plurality of gel bodies.

6: The method according to claim 5, further comprising forming the plurality of protrusions only on one of the at least one surface of each of the plurality of gel bodies, wherein the plurality of gel bodies are arranged adjacent to one another such that the at least one surface including the plurality of protrusions of one of the plurality of gel bodies faces a surface without protrusions of a respective adjacent gel body.

7: The method according to claim 5, wherein each of the plurality of protrusions comprises a circular cross-sectional shape with a diameter of 1.0 to 5.0 mm, and/or
wherein the plurality of protrusions are arranged in a regular or irregular pattern, and/or
wherein the plurality of protrusions have identical or different shapes, and/or
wherein the plurality of protrusions have a height of 0.1 mm to 20.0 mm, and/or
wherein the plurality of protrusions are arranged such that a minimum distance between outer surfaces of adjacent protrusions is 0.1 mm, and/or
wherein the plurality of protrusions are formed as truncated cones, and/or
wherein the method further comprises removing the plurality of protrusions after removing the solvent from the plurality of gel bodies.

8: The method according to claim 1, wherein the plurality of gel bodies are formed as slabs having a cuboid, cylindrical, or polygonal shape, and
wherein the plurality of gel bodies are arranged such that side surfaces of the cuboid, cylindrical, or polygonal shape having a greatest surface area are oriented substantially perpendicular with respect to a direction of gravity, or
wherein the plurality of gel bodies are arranged such that side surfaces of the cuboid, cylindrical, or polygonal shape having the greatest surface area are oriented substantially parallel with respect to a direction of gravity.

9: The method according to claim 1, wherein the plurality of gel bodies are formed as slabs comprising a length of at least 10 cm and a width of at least 10 cm, and/or
wherein the plurality of gel bodies are formed as slabs comprising a thickness of at least 0.5 mm.

10: The method according to claim 1, wherein the spacer is a grid comprising grid openings.

11: The method according to claim 10, wherein the grid openings comprise identical or different opening areas, and/or
wherein the grid openings are arranged in a regular or irregular pattern, and/or
wherein the grid comprises struts defining the grid openings, wherein the struts comprise a width of 1.0 mm to 5.0 mm, and/or
wherein the plurality of gel bodies are formed as slabs having a cuboid, cylindrical, or polygonal shape, wherein the plurality of gel bodies are arranged such that side surfaces of the cuboid, cylindrical, or polygonal shape having a greatest surface area are oriented substantially perpendicular with respect to a direction of gravity, and/or
wherein the method further comprises at least partially providing surfaces of the grid with a coating made of a material being electrically dissipative and non-sticky to the plurality of gel bodies.

12: The method according to claim 10, wherein removing the solvent from the plurality of gel bodies is performed by means of supercritical drying.

13: The method according to claim 10, wherein the grid is configured to carry each of the plurality of gel bodies and to support a second grid disposed thereon without the plurality of gel bodies being engaged by the second grid.

14: The method according to claim 1, wherein removing the solvent from the plurality of gel bodies is performed by means of supercritical drying or convective drying.

15: A plurality of gel bodies obtained or obtainable by the process according to claim 1.

16: A thermal insulation material or a vacuum insulation panel, comprising the plurality of gel bodies according to claim 15.

17: A method, comprising:
molding a thermal insulation material or a vacuum insulation panel comprising the plurality of gel bodies according to claim 15.

18: The method according to claim 3, wherein the grid assembly comprises a thickness of 1.5 mm to 2.5 mm.

19: The method according to claim 4, wherein the forming comprises monolithically forming each of the plurality of gel bodies with the spacer.

20: The method according to claim 13, wherein the grid comprises an outer rim configured to support the second grid disposed thereon, without the plurality of gel bodies being engaged by the second grid.
